(19) United States
(12) Patent Application Publication
(10) Pub. No.: US 2022/0004598 A1
(43) Pub. Date: Jan. 6, 2022

(54) NEURAL RIGHTS MANAGEMENT

(71) Applicant: Charles Saron Knobloch, Katy, TX (US)

(72) Inventor: Charles Saron Knobloch, Katy, TX (US)

(21) Appl. No.: 17/367,223

(22) Filed: Jul. 2, 2021

Related U.S. Application Data
(60) Provisional application No. 63/047,902, filed on Jul. 2, 2020.

(51) Int. Cl. G06F 21/10; G06N 3/10; H04L 29/08

(52) U.S. Cl. CPC G06F 21/10; H04L 69/326; G06N 3/10

(57) ABSTRACT

A computer-assisted method for digitally packaging data in a plurality of transport layers and delivering the digital package to a recipient. Transport layers include: a data transport, digital rights management, data broker management, granular data transport, transaction protocol, rights contract management, and neural rights management. A computer program, characterized in that the computer program product comprises instructions which, when the program is executed by a computer, cause the computer to carry out the steps of the encoding, positioning and arranging data according to the data transport protocol methods described herein. A computer-readable data carrier, characterized in that stored thereon is data encoded, positioned and arranged according to the data transport protocol methods described herein. A computer-assisted system for generating data encapsulated according to the data transport protocol methods described herein, and the system is configured to manage the access rights to the encapsulated data.

### CROSS REFERENCE OF RELATED APPLICATIONS

This present application claims the benefit of U.S. Provisional Patent Application Ser. No. 63/047,902, filed Jul. 2, 2020.

### TECHNICAL FIELD

The examples of the invention provided herein relate to methods and systems for automation of authorization and rights allocation for machine learning data and resulting trained models. In particular, disclosed herein are examples of data transport layers to effect data and rights transfer, including options for chain of title and one or more neural execution repositories. In particular, disclosed is a method for cloudless spatially-independent data storage of transported and neural-associated data.

### BACKGROUND OF THE INVENTION

Traditionally, data (including geoscience data) is stored, sold or licensed in units that are associated with its physical acquisition. Derived data is stored associated with its physical location, such as by a well or field. For example, a seismic line or 3-D survey is sold of licensed based on the field survey. A well log is sold by the logging run or in a collection of well logs from a spatial area, such as a field or basin or geographic area. Well log curves are stored based on the characteristic of the logging acquisition tool, such as a “sonic” or a “resistivity” log. Generally, data is stored, brokered, managed not by its scientific significance, characteristics, or properties to actual real-world phenomena.

As scientific investigation advances into using machine learning, neural networks and other artificial intelligence techniques, there is a growing need for access to data (including geoscience data) in granular units that are associated with observed real-world phenomena, rather than by packages of data associated with physical acquisition. Further, these scientific-investigation advances increase the need for access to multiple data examples of same or similar real-world phenomena in order to train the machine learning, neural networks and other artificial intelligence techniques. Further, once human or machine derived learned models are created, there is a need to store, transport, license, and sell in granular units associated with their associated real-world phenomena.

Traditional data sets associated with physical acquisition are generally owned by larger, centralized companies. These data sets are physically stored or otherwise centrally managed by their owners. Granular units of data results in a larger number of owners who are more greatly dispersed within their industry. Further, a granular unit of data may have a number of unrelated persons and entities who are not related to each other. Inventor discovers that granular units of data are therefore more easily lost. There is also a need to be able to store (locate, and retrieve) granular units of data in multiple world-wide locations, independent of reliance on some centralized storage location. The present invention sets out to also solve this problem.

### BRIEF DESCRIPTION OF THE DRAWING

FIG. 1 illustrates a schematic diagram of one example of stacked layers of data transport protocols to facilitate understanding of a neural rights management environment.

### DETAILED DESCRIPTION OF THE INVENTION

Disclosed herein are descriptions of various examples of the invention.

Example Industrial Application in the Field of Geoscience.

While the disclosures of the examples of this invention may be applied in many different areas of the useful arts, disclosures herein will start with examples in the field of geoscience for clarity, illustration and convenience.

In geoscience, data and information come in many different forms and from many different sources. This is particularly so in the areas of petroleum and mineral exploration and extraction, where data is gathered from a plethora of geophysical techniques, as well as direct observation the earth and extracted matter. By way of illustration, and not limitation, data is acquired from the surface, by mining, and by borehole drilling. Some of the data gathering techniques include: acoustic soundings (seismic mapping, acoustic well logs); measurement of electrical and electro-magnetic potential fields; reaction to induced electrical, electromagnetic, and nuclear fields; imagery, radar, observation of the remains of paleo life forms, observations of foliage, thin sections of retrieved rocks or geologic material; chemical analysis of extracted water, oil, gases, other materials; rock cuttings (such as mud logging); subsurface pressures and temperatures; results of extraction, such as oil or gas production data; and others techniques. All of these data come in different formats and data structures. All of these data also have varying characteristics due to the technology available at the time the data was acquired.

In simplest concept, for example, oil exploration data is primarily a picture of the subsurface generated from surface acoustic seismic and well log data from multiple well logging tools, resulting in multiple “curves” that display the reaction of the geologic beds as the tool passes down the borehole.

Beyond collection of acquired data, there are also data sets generated through computational processing and also data sets generated from from interpretative efforts on these data sets. Data from many different techniques are also synthesized to produce new data. Many of these are combined with interpretative efforts, such as in the production of prospect maps that are based on surface seismic and well log information. Other examples include combining the information from multiple well logging tools to make new curves that infer the composition of the geologic beds (such as sand versus shale versus limestone, the corresponding inferred porosity, the presence of oil or gas or water).

Other interpretative information is gathered, based on observation of patterns in the raw, processed, and synthesized data. For example, a well log may exhibit a pattern in the log data that is recognized as a particular geologic depositional history (such as a gradational change with depth in the amount of sand versus shale in the laminations of the geologic layers). For example, the sequence of paleo life form fossils indicate the geologic time period of creation of the geologic bed and may also indicate the depositional environment (tropical or temperate, marine versus fresh water, etc). These synthesized or newly created data are scattered in may forms, structures, and formats.

As the prospector recognizes patterns in the data, such as an indication of depositional environment or type of geologic bedding, some of these data observations are granulized and become useful to recognize similar patterns in other prospects. Unfortunately, both prospects and prospectors are scattered around the world—and so are the valuable granulized data. There is a great need to be able to gather these data to create machine learning sets to improve a prospector's ability to locate and identify prospects. The same applies to prospect developers, such as reservoir engineers who improve the extraction of petroleum resources from an existing field.

One problem arises in data ownership. Another problem arises in work-product monetization. Another problem is that of tracking data veracity and integrity. A company may wish to contribute its granulized data, such as examples of a log curve pattern that identifies a particular geologic environment, but these problems may prevent them from contributing the data to a machine learning data set.

To solve this problem, the granulized data is encapsulated into an encrypted block chain that carries the owner identification, licensing, and royalty monetization requirements.

In one example, the trained neural data set is encapsulated into an encrypted block chain that carries the owner identification, licensing, and royalty monetization requirements.

In one example, the encrypted block chains include readable pattern identifiers that indicate the context of the data block.

For example, if a prospector has assembled a training set of log responses to oil-water contacts for a particular geologic play, the appropriate pattern identifiers will be placed in the readable portion of the block. In one example, the identifiers have a “parent and sibling” data structure.

The encrypted block chains are then freely promoted and shared. In one example, access to the data in the block is gained by connecting with a licensing server that records and monetizes the access. Since the data block is being used to create another data block (such as a larger training set or the resulting neural block), in one example, the digital rights information is transferred and added to the new data block.

In a particular example, a prospector has a set of exemplary log curves that identify a particular pattern. The prospector is interested only in receiving a fee each time the prospector's data is purchased. The prospector is not interested in collecting additional royalties in derived works. A purchaser might purchase the data set and receive the data block. The set of restrictions on the opening of that data block that now resides on the purchaser's storage resources is based on the licensing server. Here, the purchaser may have extracted the exemplary log curves and uses them at will, independent of the data block. However, should the purchaser send a copy of the data block to another person, then the licensing server will require a new purchase from the new person. This is a great advantage. In a further example, since copies of the data block may be scattered around the world, the licensing server(s) are notified every time one of the scattered data blocks is activated in some way. In this example, the licensing server(s) can have the ability to keep a log of where copies of the data block are around the world. This may be used to locate lost data, search for potential users, marketing of similar data, perform searches for buyers.

In another example, the prospector (or, originator of the data block) may want to keep an ownership interest in new data blocks that incorporate (or were derived from) the prospector's original data block. In this case, the licensing server only effects transfer of data and rights management information of the original data block into the new data block. The buyer is not allowed to extract the original block data except under the management of the licensing server(s).

As can be appreciated, the workflow steps herein described are reduced to practice through computer code that is executed on one or more computing devices.

Neural Rights Management Environment—System and Methods.

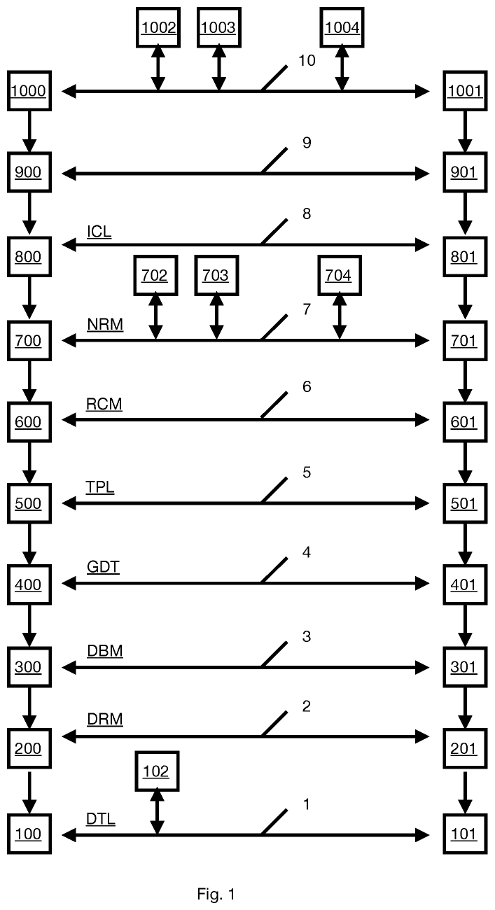

FIG. 1 illustrates a schematic diagram of one example of stacked layers of data transport protocols to facilitate understanding of a neural rights management environment. The use of transport layers helps to form an understanding of one example way to build up a foundation of functionalities to enable neural rights management in an eco-system.

Using this example, starting with the base or foundation of the transport layers, one foundational layer is called a data transport layer 1 (DTL). The DTL functions to enable delivery of data between customers (eg., the system interfaces between a data provider 100 and a data consumer 101). In one example, the DTL enables intermediate storage of data. In one example, a trackable unit of data passing through the DTL “platform” is called a “package” or “data package” or “DTL package”.

Building on the DTL data transport layer, a digital rights management (DRM) layer 2 determines who is allowed access to what data and when. In one example, the DRM layer keeps a record of usage of those rights that pass through the DTL “platform”. In one example, the usage record is chained onto the data package.

With the DTL and DRM layer capabilities in place, a data broker management (DBM) transport layer 3 enables offering of data for purchase or license. In one example, base level DRM features are accessed to effect or restrict actual data transport, based on the command of the DBM layer. In one example, the DBM provides capability for automatic purchases. In one example, the DBM provides capability for automatic settlements.

The functionalities of the DTL, DRM, and DBM layers provide an example basis for adding granular data transport (GDT) layer 4 capabilities. A GDT layer enables delivery of small portions of data that is relevant to the scientist or engineer. In one example, a geoscientist desires to transport a collection of well log responses for a particular geologic window. In one example, an engineer desires to transport data on the performance of a particular type of pump. The types and formats of granular data to be transported are vast and generally independent of the original acquisition data structures.

The application of granular data transport increases the need for greater management and verifiable oversight of the data transport jobs. The various desired or required capabilities, in this example, are presented in a transaction protocol layer 5 (TPL). In one example, two closely related functionalities are included in the TPL. One is transaction records management (TRM) and another is transaction history recording (THR).

In one example, the TPL functions to enable recording and appending to an abstract of title for the data package. In one example, the abstract of title is incorporated into the data package. In one example, the abstract of title is formed as a block chain. In one example, a scientific fraud protection layer is incorporated into the data package, for example, a geoscience fraud protection layer. In one example, a long term usage history of the data package is kept and wrapped with the data. This enables verification of the veracity of the data (eg, data fraud protection), including record of the parent data and record of persons or entities from which the data was derived. In one example, the data history is blockchain augmented.

In one example, given the capabilities of the preceding transport protocol layers, a rights contract management (RCM) layer 6 is added. The RCM layer enables data owners to have desired service contracts in place, ready for expeditious electronic-execution to authorize and enable data transport. In one example, the contracts supervise the DRM layer, with recordation of the contracts into the historical abstract by the TPL (TRM/THR) layer.

With the preceding capabilities enabled, a neural rights management (NRM) protocol layer 7 becomes practical. In one example, the preceding capabilities are bundled into an overall neural rights management protocol. However, these escalating functionalities are illustrated as layers of data transport protocols to show one example of staged implementation of escalating capabilities and functionalities. In one example, the NRM layer enables access to one or more types of neural clusters 702. Examples include training sets, machine-learned models, etc. In one example, DRM and DBM functionalities perform to reduce friction in offering, acquiring, transporting, storing, and using neural data packages.

In one example, the NRM layer includes the functionality to process or otherwise consume neural data packages. In one example the NRM transport layer includes one or more tap points 703 to utilize authorized neural data packages to grow machine learning models. In one example, neural processing is offered by tapping any data passing through or stored in the DTL.

In one example, the NRM layer includes an execution repository 704. In this example, data processing modules are transported to the execution repository to be available for ingestion of data packages and information production resulting from the ingestions. In one example, one or more of the preceding layers is used to facilitate brokering of the rights and royalties associated with the data ingestion and resulting information creation.

Once neural rights management functionalities are available, an information creation layer 8 (ICL) enables creation of derived data. In one example, creation of derived data includes one or more of manual effort of experts, machine learned—artificial intelligence, or a hybrid of manual expert effort with machine learned analysis. In one example, the ICL layer is facilitated by utilizing (checking) the DRM layer, recording using the TRM layer, and performing settlements through the DBM layer.

At this point, the neural rights management is augmented by management of data broker management and management of software access.

The broker management layer 9 (BML). For example, the preceding layers, including the NRM layer and NRM execution repository, generate an exploding number of possible royalty owners. Similar to ownership records of mineral interests, these owners will appear and disappear with time. Death, abandonment, bankruptcies, mergers, acquisitions, divorces will all obscure the ownership record and chain of title. A broker management layer (BML) enables registration and tracking of owners who are establishing ownership or royalty interests in data packages created or transported through the protocol layers. In one example, the BML also establishes one or more legal frameworks for springing conditions that may occur over time with ownership and royalty rights of data packages. For example, death, abandonment, bankruptcies, mergers, acquisitions, divorces, license expiration are springing conditions which cloud title to data packages. In one example, the BML periodically appends information to the abstract of title.

The software access layer 10 (SAL). As industrial use of data transforms from data sets organized or structured by their physical acquisition to data sets organized or structured by their real-world phenomena, there is also a transformation in the type of processing software to be used. With the data protocol transport model, pipeline processing of data is expanded from its traditional role of internal central computer processing of images to distributed network pipeline processing of data packages by individual end users. This transforms the type of software required by industrial end users.

In one example, a software access layer (SAL) enables procurement of access or usage rights to industry software packages, including execution code fragments 1002 to be applied to the data packages being transported. For example, data conditioning of neural data needs to be procured as part of the data transport process, rather than as a stand alone computer program that reads and writes files on the user's computer. In one example, the SAL enables access or usage privileges to SAAS platforms 1003. In one example, the access or usage licenses are granular to specific data being processed using the software. Data to be used for neural processing in many cases needs to be transformed into a format that can be ingested for processing. In one example, the SAL facilitates conditioning 1004 of data tapped from the DTL to formats needed by the packages. Note, that data conditioning is an important service line (automated, manual, or hybrid) that can be set up to be purchased “on-demand”. Twenty traditional data analysis software packages, for example, cause the need for up to 400 conditioning combinations.

Cloudless Spatially Independent Data Storage.

The information transfer protocol described herein provides one example way to decouple industrial information from needing centralized (datacenter or “cloud”) storage and from structured format data storage. In the never ending debate over structured versus unstructured data storage, information transfer protocol and advanced protocol layers such as GDT and NRM layers greatly reduce the need for centralized structured data storage. Further, it becomes possible for data packages to be stored “where they lie” and to be stored in multiple locations, similar to a world wide traditional network of public book libraries. Such an architecture increases the assurance from data loss, reduces data storage costs, and provides a natural and seamless evolution away from massive data centers. Such an architecture also increases the fungibility of data packages for marketing and revenue generation.

Instead of storing data “in the cloud” meaning in a particular place (or “data room”) the data is encrypted and bundled into a file that can only be accessed by using a remote authority. The file resides anywhere in the world—thus, the file can have multiple copies. Each time access is attempted, a remote authority is pinged and the remote authority can log where that file is located and when the ping occurred.

In one example, the file includes a rights and use history. In one example, information on derivative files are recorded in the use history. In one example, the rights and use history are block-chained.

In one example, the file is made into an executable. This allows the file to self launch and automatically talk to the remote authority.

In one example, a service company generates a data file for a client company. The service company delivers the data file to the client company. The service company generally has no rights to the data in the data file. However, in this example, the service company also keeps a copy of the file, even if the service company is not supposed to. Should the client company lose its copy the data file, the remote authority can report whether there is another copy (copies) anywhere in the world.

In one example, a secondary file (“stub”) has public info about the file and that stub can be used to “hunt” world wide for copies of that file.

In one example, the data package is embedded into a publicly known file format that includes executable code. In one example, the data package is embedded into a PDF file format that includes executable code. The executable code first interfaces with a/the remote authority in order to proceed with operations on the embedded data package. In the public file format (eg, PDF format) that is used, information can be communicated to the user who is opening the file. For example, for a PDF file, the opened file contains one or more PDF pages that describe the locked data package with instructions to the user as to how to gain access to the locked data, which may include links to webpages for further user authentication or point of sale transactions.

### Preferred Examples

In a first set of examples, disclosed is a computer-assisted method for communicating data between a plurality of computers comprising:
digitally packaging the data in a plurality of transport layers, whereby a digital data package is created;
delivering the digital package to a recipient;
wherein the plurality of transport layers are selected from:
   a data transport layer (DTL), a digital rights management (DRM) layer, a data broker management (DBM) transport layer, a granular data transport (GDT) layer, a transaction protocol layer (TPL), a rights contract management (RCM) layer, a neural rights management (NRM) protocol layer, an information creation layer (ICL), a broker management layer (BML), and a software access layer (SAL);
wherein the right to access the data contained in the digital packaging is controlled by one or more of the plurality of transport layers.

In further example, the neural rights management (NRM) transport layer includes one or more tap points to utilize authorized neural data packages to grow machine learning models.

In further example, the neural processing is offered by tapping data passing through or stored in the data transport layer (DTL). In further example, the neural rights management (NRM) transport layer includes an execution repository, a data processing module is transported to the execution repository to be available for ingestion of data packages and for producing information resulting from the ingestions. In further example, the one or more of the selected plurality of transport layers is used to facilitate brokering of the rights and royalties associated with the data ingestion and resulting information creation.

In further example, the neural processing is offered by tapping any data passing through or stored in the data transport layer (DTL). In further example, the neural rights management (NRM) transport layer includes an execution repository, a data processing module is transported to the execution repository to be available for ingestion of data packages and for producing information resulting from the ingestions. In further example, the one or more of the selected plurality of transport layers is used to facilitate brokering of the rights and royalties associated with the data ingestion and resulting information creation.

In further example, the data transport layer (DTL) enables intermediate storage of data.

In further example, the transaction protocol layer (TPL) functions to enable recording and appending to an abstract of title for the data package. In further example, the abstract of title is incorporated into the data package. In further example, the contracts are recorded into the abstract of title. In further example, the broker management layer (BML) periodically appends information to the abstract of title.

In further example, a scientific fraud protection layer is incorporated into the data package.

In further example, a long term usage history of the data package is kept and wrapped with the data.

In further example, the rights contract management (RCM) layer supervises the digital rights management (DRM) layer.

In further example, the data package is made into a self-launching executable that self-connects a communications socket to a remote authority server.

In further example, the data package comprises a secondary file or stub presenting public information about the data package, whereby capability is exposed to perform public network searches for the data package.

In further example, the data package is embedded into a publicly known file format that includes executable code. In further example, the data package is embedded into a PDF file format that includes executable code. In further example, the executable code interfaces with a remote authority in order to proceed with operations on the data package.

In further example, the neural rights management (NRM) transport layer enables access to one or more types of neural clusters. In further example, the digital rights management (DRM) layer and the data broker management (DBM) transport cooperate with the neural rights management (NRM) transport layer in offering, acquiring, transporting, storing, and using neural data packages. In further example, the neural rights management (NRM) transport layer further processes or otherwise consumes neural data packages.

In a second set of examples, for the computer-assisted method for communicating data between a plurality of computers, the selected plurality of transport layers comprise:
a data transport layer (DTL), a digital rights management (DRM) layer, a data broker management (DBM) transport layer, a granular data transport (GDT) layer, a transaction protocol layer (TPL), a rights contract management (RCM) layer, and a neural rights management (NRM) transport layer.

In further example, the neural rights management (NRM) transport layer includes one or more tap points to utilize authorized neural data packages to grow machine learning models.

In further example, the neural processing is offered by tapping any data passing through or stored in the data transport layer (DTL). In further example, the neural rights management (NRM) transport layer includes an execution repository, a data processing module is transported to the execution repository to be available for ingestion of data packages and for producing information resulting from the ingestions. In further example, the one or more of the selected plurality of transport layers is used to facilitate brokering of the rights and royalties associated with the data ingestion and resulting information creation.

In further example, the selected plurality of transport layers additionally comprise one or more of: an information creation layer (ICL), a broker management layer (BML), and a software access layer (SAL). In further example, the information creation layer (ICL) manages derived data generated from one or more of:
manual effort of experts, machine learned analysis, or a hybrid of manual expert effort with machine learned analysis.

In further example, the information creation layer (ICL) is facilitated by utilizing the digital rights management (DRM) layer, recording using a transaction records management (TRM) function in the transaction protocol layer (TPL), and performing settlements through the data broker management (DBM) transport layer. In further example, the broker management layer (BML) enables registration and tracking of owners who are establishing ownership or royalty interests in data packages created or transported through the protocol layers. In further example, the software access layer (SAL) enables procurement of access or usage rights to industry software packages, including execution code fragments to be applied to the data packages being transported.

In further example, the software access layer (SAL) facilitates conditioning of data tapped from the data transport layer (DTL) to formats needed by industry software packages.

In further example, the data transport layer (DTL) enables intermediate storage of data.

In further example, the transaction protocol layer (TPL) functions to enable recording and appending to an abstract of title for the data package. In further example, the abstract of title is incorporated into the data package. In further example, the contracts are recorded into the abstract of title. In further example, the broker management layer (BML) periodically appends information to the abstract of title.

In further example, a scientific fraud protection layer is incorporated into the data package.

In further example, a long term usage history of the data package is kept and wrapped with the data.

In further example, the rights contract management (RCM) layer supervises the digital rights management (DRM) layer.

In further example, the data package is made into a self-launching executable that self-connects a communications socket to a remote authority server.

In further example, the data package comprises a secondary file or stub presenting public information about the data package, whereby capability is exposed to perform public network searches for the data package.

In further example, the data package is embedded into a publicly known file format that includes executable code. In further example, the data package is embedded into a PDF file format that includes executable code. In further example, the executable code interfaces with a remote authority in order to proceed with operations on the data package.

In further example, the neural rights management (NRM) transport layer enables access to one or more types of neural clusters. In further example, the digital rights management (DRM) layer and the data broker management (DBM) transport cooperate with the neural rights management (NRM) transport layer in offering, acquiring, transporting, storing, and using neural data packages. In further example, the neural rights management (NRM) transport layer further processes or otherwise consumes neural data packages.

In one set of examples, disclosed herein is a computer program, characterized in that the computer program product comprises instructions which, when the program is executed by a computer, cause the computer to carry out the steps of the encoding, positioning and arranging data according to the data transport protocol methods described herein.

In one set of examples, disclosed herein is a computer-readable data carrier, characterized in that the computer-readable data carrier has stored thereon data encoded, positioned and arranged according to the data transport protocol methods described herein.

In one set of examples, disclosed herein is a computer-assisted system for generating data encapsulated according to the data transport protocol methods described herein, and the system is configured to manage the access rights to the encapsulated data.

### CONCLUSION

As can be appreciated, the workflow steps herein described are reduced to practice through computer code that is executed on one or more computing devices. In one example, a virtual workstation is constructed to operate on a computing device that includes a display that also receives hand input from the user. The user looks at the data being interpreted, modifies the data, and then encapsulates the modified data according to the methods described herein. The encapsulated data is then transmitted to recipients across a computer network.

It is clear to a person skilled in the art that the statements set forth herein are reduced to practice through the implementation of hardware circuits, software means or a combination thereof. The software means can be related to programmed microprocessors or a general computer, an ASIC (Application Specific Integrated Circuit) and/or DSPs (Digital Signal Processors). For example, the common computing infrastructure, user (equipment), computer-assisted method and computer-assisted system may be implemented partially as a computer, a logical circuit, an FPGA (Field Programmable Gate Array), a processor (for example, a microprocessor, microcontroller (μC) or an array processor)/a core/a CPU (Central Processing Unit), an FPU (Floating Point Unit), NPU (Numeric Processing Unit), an ALU (Arithmetic Logical Unit), a Coprocessor (further microprocessor for supporting a main processor (CPU)), a GPGPU (General Purpose Computation on Graphics Processing Unit), a multi-core processor (for parallel computing, such as simultaneously performing arithmetic operations on multiple main processor(s) and/or graphical processor(s)) or a DSP.

It is further clear to the person skilled in the art that even if the herein-described details will be described in terms of a method, these details may also be implemented or realized in a suitable device, a computer processor or a memory connected to a processor, wherein the memory can be provided with one or more programs that perform the method, when executed by the processor. Therefore, methods like swapping and paging can be deployed.

It is further clear that the information or data to be transported across a network of computers is positioned, arranged, and encapsulated into the data structures and information pursuant to the herein-described methods, which is then placed in a physical memory device for transport or retrieval at a later point in time. Examples of physical memory include solid state memory, disk drives, portable USB interfaced memory sticks, laser disks, and intermediate data transport physical storage medium.

Although the present invention is described herein with reference to a specific preferred embodiment(s), many modifications and variations therein will readily occur to those with ordinary skill in the art. Accordingly, all such variations and modifications are included within the intended scope of the present invention as defined by the reference numerals used.

From the description contained herein, the features of any of the examples, especially as set forth in the claims, can be combined with each other in any meaningful manner to form further examples and/or embodiments.

The foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to enable others skilled in the art to utilize the invention and such or other embodiments and with various modifications required by the particular applications or uses of the invention.

1. A computer-assisted method for communicating data between a plurality of computers comprising:
digitally packaging the data in a plurality of transport layers, whereby a digital data package is created;
delivering the digital package to a recipient;
wherein the plurality of transport layers are selected from:
a data transport layer (DTL), a digital rights management (DRM) layer, a data broker management (DBM) transport layer, a granular data transport (GDT) layer, a transaction protocol layer (TPL), a rights contract management (RCM) layer, a neural rights management (NRM) protocol layer, an information creation layer (ICL), a broker management layer (BML), and a software access layer (SAL);
wherein the right to access the data contained in the digital packaging is controlled by one or more of the plurality of transport layers.

2. The computer-assisted method of claim 1, wherein the data transport layer (DTL) enables intermediate storage of data.

3. The computer-assisted method of claim 1, wherein the transaction protocol layer (TPL) functions to enable recording and appending to an abstract of title for the data package.

4. The computer-assisted method of claim 3, wherein the abstract of title is incorporated into the data package.

5. The computer-assisted method of claim 3, wherein the contracts are recorded into the abstract of title.

6. The computer-assisted method of claim 3, wherein the broker management layer (BML) periodically appends information to the abstract of title.

7. The computer-assisted method of claim 1, wherein a scientific fraud protection layer is incorporated into the data package.

8. The computer-assisted method of claim 1, wherein a long term usage history of the data package is kept and wrapped with the data.

9. The computer-assisted method of claim 1, wherein the rights contract management (RCM) layer supervises the digital rights management (DRM) layer.

10. The computer-assisted method of claim 1, wherein the data package is made into a self-launching executable that self-connects a communications socket to a remote authority server.

11. The computer-assisted method of claim 1, wherein the data package comprises a secondary file or stub presenting public information about the data package, whereby capability is exposed to perform public network searches for the data package.

12. The computer-assisted method of claim 1, wherein the data package is embedded into a publicly known file format that includes executable code.

13. The computer-assisted method of claim 12, wherein the data package is embedded into a PDF file format that includes executable code.

14. The computer-assisted method of claim 12, wherein the executable code interfaces with a remote authority in order to proceed with operations on the data package.

15. The computer-assisted method of claim 1, wherein the selected plurality of transport layers comprise:
a data transport layer (DTL), a digital rights management (DRM) layer, a data broker management (DBM) transport layer, a granular data transport (GDT) layer, a transaction protocol layer (TPL), a rights contract management (RCM) layer, and a neural rights management (NRM) transport layer.

16. The computer-assisted method of claim 15, wherein the neural rights management (NRM) transport layer includes one or more tap points to utilize authorized neural data packages to grow machine learning models.

17. The computer-assisted method of claim 15, wherein the neural processing is offered by tapping data passing through or stored in the data transport layer (DTL).

18. The computer-assisted method of claim 17, wherein the neural rights management (NRM) transport layer includes an execution repository, a data processing module is transported to the execution repository to be available for ingestion of data packages and for producing information resulting from the ingestions.

19. The computer-assisted method of claim 17, wherein the one or more of the selected plurality of transport layers is used to facilitate brokering of the rights and royalties associated with the data ingestion and resulting information creation.

20. The computer-assisted method of claim 15, wherein the selected plurality of transport layers additionally comprise one or more of:
an information creation layer (ICL),
a broker management layer (BML), and
a software access layer (SAL).

21. The computer-assisted method of claim 20, wherein the information creation layer (ICL) manages derived data, the derived data generated from one or more of:
manual effort of experts, machine learned analysis, or a hybrid of manual expert effort with machine learned analysis.

22. The computer-assisted method of claim 20, wherein the information creation layer (ICL) is facilitated by utilizing the digital rights management (DRM) layer, recording using a transaction records management (TRM) function in the transaction protocol layer (TPL), and performing settlements through the data broker management (DBM) transport layer.

23. The computer-assisted method of claim 20, wherein the broker management layer (BML) enables registration and tracking of owners who are establishing ownership or royalty interests in data packages created or transported through the protocol layers.

24. The computer-assisted method of claim 20, wherein the software access layer (SAL) enables procurement of access or usage rights to industry software packages, including execution code fragments to be applied to the data packages being transported.

25. The computer-assisted method of claim 20, wherein the software access layer (SAL) facilitates conditioning of data tapped from the data transport layer (DTL) to formats needed by industry software packages.

26. The computer-assisted method of claim 15, wherein the neural rights management (NRM) transport layer enables access to one or more types of neural clusters.

27. The computer-assisted method of claim 26, wherein the digital rights management (DRM) layer and the data broker management (DBM) transport cooperate with the neural rights management (NRM) transport layer in offering, acquiring, transporting, storing, and using neural data packages.

28. The computer-assisted method of claim 27, wherein the neural rights management (NRM) transport layer further processes or otherwise consumes neural data packages.
